(19) United States
(12) Patent Application Publication
(10) Pub. No.: US 2019/0087768 A1
(43) Pub. Date: Mar. 21, 2019

(54) SUPPORTING INSPECTION WORK SYSTEM, SUPPORTING INSPECTION WORK METHOD, AND STORAGE MEDIUM

(71) Applicant: Kabushiki Kaisha Toshiba, Tokyo (JP)

(72) Inventors: Hiroshi Fujimura, Yokohama Kanagawa (JP); Nayuko Watanabe, Kawasaki Kanagawa (JP); Uihyun Kim, Kawasaki Kanagawa (JP)

(21) Appl. No.: 15/916,071

(22) Filed: Mar. 8, 2018

(30) Foreign Application Priority Data
Sep. 20, 2017 (JP) 2017-180713

(51) Int. Cl. G06Q 10/06; G06F 17/30

(52) U.S. Cl. CPC G06Q 10/063112; G06F 17/30477

(57) ABSTRACT

According to one embodiment, an inspection work support system includes a memory device, a detector, and a change processor. The memory device stores a work manual including a predetermined work content and a predetermined wok procedure, and worker information on a worker engaged in the work. The detector detects input from the worker. The change processor changes a method of presenting a content and a procedure of the work manual based on the input from the worker, based on a skill level of the worker for the work obtained referring to the worker information.

### CROSS-REFERENCE TO RELATED APPLICATIONS

This application is based upon and claims the benefit of priority from Japanese Patent Application No. 2017-180713, filed Sep. 20, 2017, the entire contents of which are incorporated herein by reference.

### FIELD

Embodiments described herein relate generally to a system, a method, and a storage medium for supporting an inspection work.

### BACKGROUND

In these days, dialog systems using speech have been employed for various business inspection works of equipment inspection, maintenance and inspection, and the like. The systems present work contents and work procedure to inspection workers. In contrast, presentation of the work procedure according to the worker's skill levels is required consideration of complexity of the inspection work and increase in the number of steps due to the sophistication of the business.

If the skill levels are not considered, inappropriate cases for the workers may occur and inspection errors and reduction in efficiency may be caused since the presented contents are sophisticated and complicated.

### BRIEF DESCRIPTION OF THE DRAWINGS

FIG. 1 is a block diagram schematically showing an inspection work support system according to embodiments.

FIG. 2 is a flowchart showing a flow of processing in Embodiment 1.

FIG. 3 is a flowchart showing a flow of processing in Embodiment 2.

FIG. 4 is a conceptual diagram showing an example of supporting a concrete work procedure in Embodiment 2.

FIG. 5 is a flowchart showing a flow of processing in Embodiment 3.

FIG. 6 is a block diagram showing a basic configuration of a computer device applicable to a system according to the embodiments.

### DETAILED DESCRIPTION

in general, according to one embodiment, an inspection work support system includes a memory device, a detector, and a change processor. The memory device stores a work manual including a predetermined work content and a predetermined wok procedure, and worker information on a worker engaged in the work. The detector detects input from the worker. The change processor changes a method of presenting a content and a procedure of the work manual based on the input from the worker, based on a skill level of the worker for the work obtained by referring to the worker information.

Various embodiments will be described hereinafter with reference to the accompanying drawings.

The embodiments relate to a dialog type inspection work support system responding to speech from an inspection worker. This system is employed when, for example, the user executes works such as inspection, maintenance, management, and the like of equipment. For example, a content which the user has uttered during the inspection work is detected in a manual of the preliminarily registered inspection work, and a manual and the like necessary for the user are presented. An inspection work will be explained below as an example, but support of the work executed by the user is not limited to this. For example, the system may relate to support on the procedure of the confirmation work and device operations in a manufacturing process.

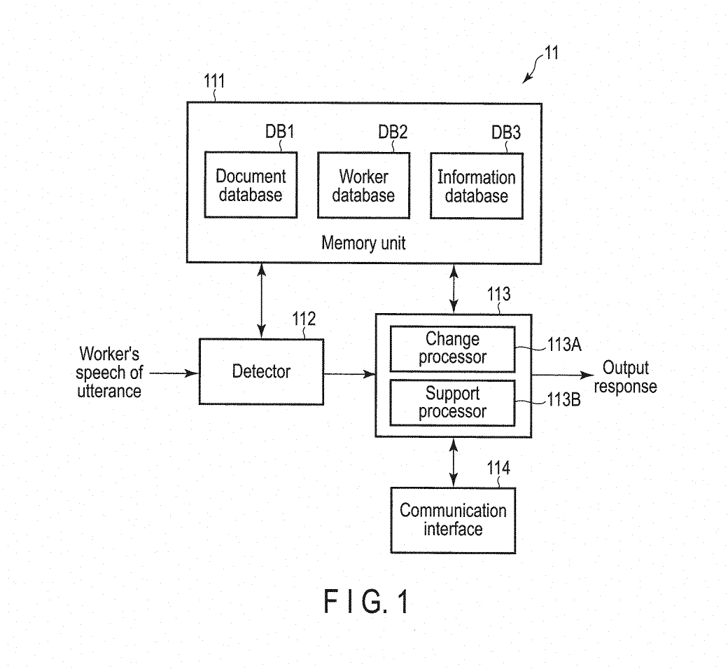

FIG. 1 is a block diagram schematically showing an inspection work support system according to the embodiments. A system 11 shown in FIG. 1 comprises a memory unit 111, a detector 112, a processor 113, and a communication interface 114. The memory unit 111 comprises a document database DB1 which stores contents of a predetermined inspection work, a work manual describing the work procedure, and the like, and a worker database DB2 which stores information for identifying a user (hereinafter called a worker) engaged in the inspection work and information (hereinafter called worker information) on the time in which the worker has been engaged in each work, and the like.

The detector 112 detects contents which the worker has uttered during the work. For example, the detector 112 acquires the work manual related to the inspection work in which the worker is engaged, the time in which the worker engaged in the work has been engaged in the work, and the like, by referring to the document database DB1 and the worker database DB2, at the disclose of the inspection work. The skill level of the inspection worker at a specific work is determined in a predetermined method. For example, a skilled worker may be selected if a total engagement time of the work is reviewed and exceeds a predetermined time, or criterion on the number of works finished in a determined work time, and the like may be set. In addition, the skill level may be determined by using a method of utilizing whether a plurality of works can be executed together or not as an evaluation value, frequency of questions to the system, fillers based on speech recognition, a feature such as hesitations, and the like. The system may output the optimum worker as a result of machine learning by setting an evaluation value of a work integrating these and learning the evaluation value for each worker. For example, well experienced and highly skilled workers may be registered as supporters. In contrast, workers of lower skill levels having no experience of the work or having no work time satisfying a predetermined threshold value may be classified into beginners.

The work content needs to be specified in the input, made by the workers but, for example, such specification in the utterance on the work procedure via a microphone is executed by speech recognition. When confirming a specific work procedure is assumed, the input speech of utterance of the inspection worker is first detected. Next, the detected speech is recognized, and the speech content is collated with the work content acquired from the document database DB1. The result of collation is transmitted to the processor 113 together with the skill level of the inspection worker.

The processor 113 acquires the skill level and the result of matching. In addition, the processor 113 acquires the work manual of the worker's engagement. The processor 113 changes presentation of a next work content, or a next work procedure in accordance with the skill level. The processor 113 may comprise a support processor 113B other than a change processor 113A which changes the next content. If the worker asks a question about the inspection work, for example, the support processor 113B searches data considered as a response in an information database DB3 and presents the search result as the answer to the question.

The system 11 may function as an artificial intelligence (AI) assistant.

In addition, if not the confirmation of the work procedure, but the question about the work itself is asked, the system 11 responds to the worker by referring to separately prepared information database DB3. The information database DB3 includes basic explanations on the processes and devices, explanations on operations, Q & A collection, and the like described in each manual used by the user. For example, questions of frequency higher according to the skill level and their answers may be prepared independently.

For example, if the worker does not know a location of an object of interest, and the like, the system 11 presents an explanation of the location by confirming the worker's current location. Alternatively, the system 11 may acquire a map showing the location of the object from the information database DB3 and send the map to a terminal held by the worker. For example, if the content of the question relate to error display (signal display of abnormal operation) of the device, the system 11 may present a method of responding to the error display. If the explanations are presented to a beginner of particularly low skill level, registered information may not be presented, but a communication line between the supporter and the worker may be connected to enable direct dialog. In addition, if no answer is included in the information database DB3, the system may present a content to enable communication with the registered supporter.

### Embodiment 1

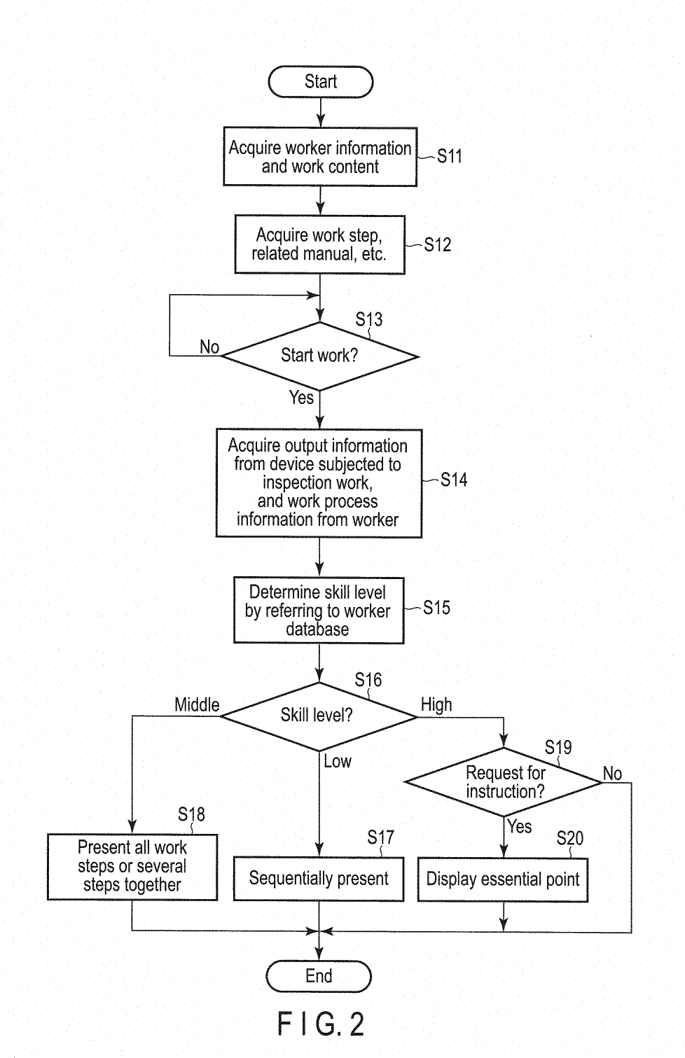

Support processing of the inspection work support system according to the embodiments will be explained below. It is assumed that the information on progress of the inspection work is successively registered by the progress information input of the inspection worker and the sensor output from the devices. As shown in FIG. 2, the system 11 first acquires the worker information and the work content (step S11). The system 11 acquires the manual related to the work step from the document database DB1 (step S12). Next, when the worker starts the work, the system 11 acquires output from the device subjected to the inspection work and the worker's work process information (steps S13 and S14). If the output from the device cannot, be obtained in relation to the work, the worker inputs an instruction of the work start. The system 11 determines the skill level in a predetermined method by referring to the worker database DB2 (step S15).

If the worker is the worker (beginner) of low skill level, the system 11 sequentially presents the work steps (steps S16 and S17). The work result can be often acquired by the device output or the like but, if the skill level is low, the system 11 may present a next work to urge the worker to sequentially report work, when the worker reports the work end. The previous and subsequent steps may be presented together in accordance with the work type, and reception of the report may be handled as a trigger of presentation of a next support item. If the worker is the worker of high (not “low”) skill level, the system 11 presents, for example, all or several steps (step S18). In addition, an essential point alone may be presented as the explanation of each of the steps. Alternately, the system 11 may urge the worker to summarize the work within a range in which the report is required, and to report the result.

The system 11 is set to present nothing particular to the worker of high skill level who is registered separately as the supporter until receiving the report or acquiring the worker's request such as asking a question (or to present the essential point if the worker requests information) (steps S19 and S20). An appropriate response can be thereby implemented without waste in accordance with the worker's skill level and the improvement in the work efficiency can be attempted.

### Embodiment 2

Next, a case where a system 11 executes the work support by considering the work progress and the worker's skill level will be explained. First, the system 11 acquires the work information, the work contents, the manual related to the work steps, and the like, similarly to the above-explained Embodiment 1. The worker's start of the work, instructions of the work steps, and the like are the same as those of Embodiment 1.

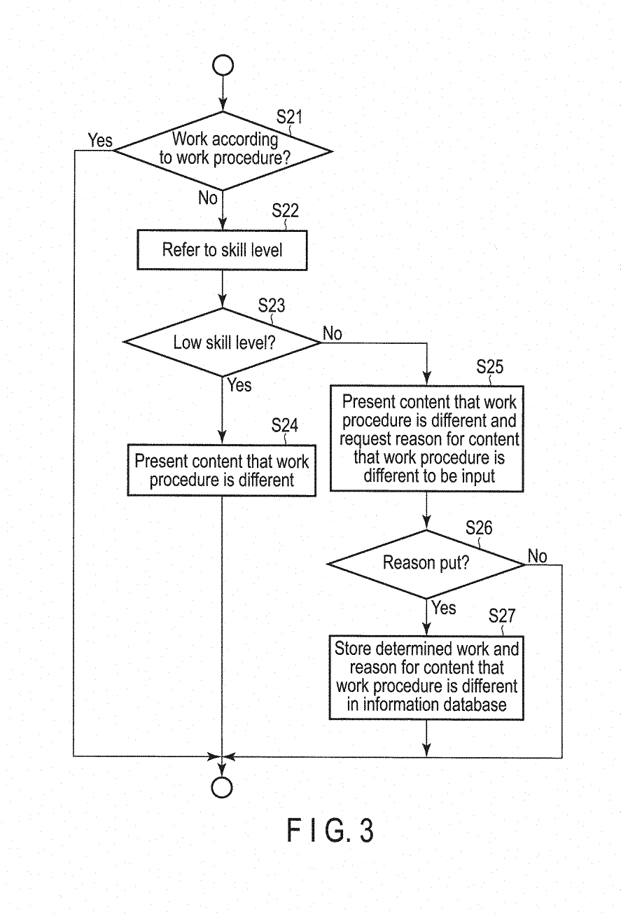

Next, as shown in FIG. 3, the system 11 collates the work steps with predetermined work procedure (step S21). More specifically, the system 11 collates detailed work steps acquired from the document database DB1 with the worker's reported steps. If the output signal of the device is obtained and the order of operations is obtained, the system 11 may collate the work steps with them. If the work is not executed in the predetermined work procedure, the system 11 refers to the worker's skill level (step S22). If the worker of low skill level is executing the work in steps different from the predetermined work procedure, the system 11 presents a content that the worker's work procedure are different (steps S23 and S24). Alternatively, the system 11 may give the user a notice by presenting a notice that the user is executing wrong operations or presenting current work steps. In contrast, if the worker of high skill level (the worker of not low skill level) is executing the work in steps different from the predetermined work procedure, for example, the system 11 presents information that the worker's work procedure is different from the determined work procedure and urges the worker to input the reason why the work steps are different from general steps (step S25). If the worker responds to the system 11, the system 11 stores the determined work and the reason why the steps of the determined work are different from the actual work steps in the information database DB3 (steps S26 and S27). The user (manager or the like) using the system can thereby take the information stored in the system 11 together. In addition, the information can be used for change of the work procedure and the like as needed. The system may update the method of presenting the steps to the worker when, for example, the work steps are improved by the method of presenting the work procedure.

A more specific example of supporting the work procedure will be explained below.

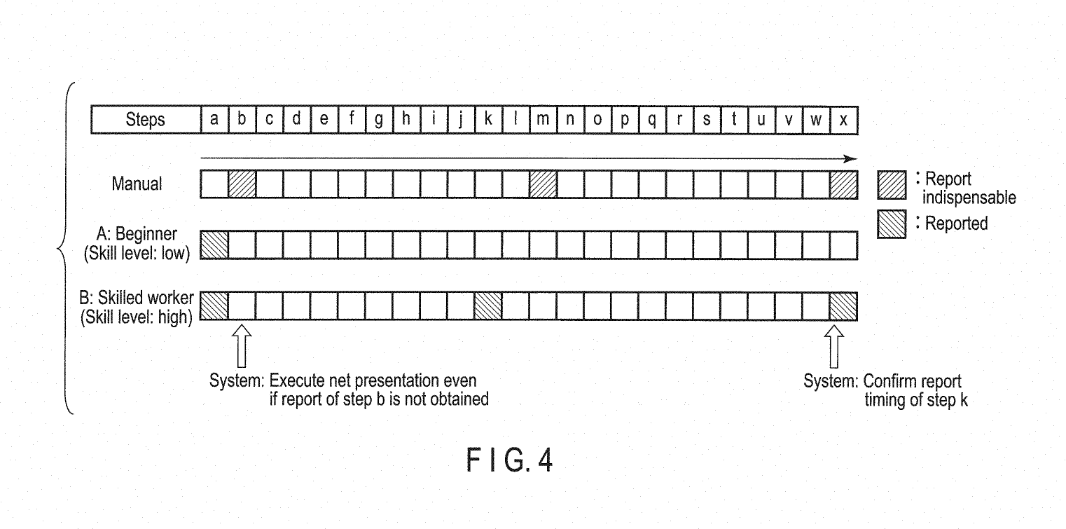

It is assumed that as shown in FIG. 4, for example, the inspection work from step a to step x is predetermined. The worker is presented information for executing the work in the steps from the support system. In addition, the system 11 acquires a work report from the manual of the inspection work when works in step b, step m, and step x are completed.

If the worker is a new worker A (beginner) of low skill level, the system 11 presents details of support information for each step to the worker. However, if a situation report is not input in step b by the worker A, the system 11 urges the worker A to send the situation report without presenting information that the next step is step c. In contrast, the system 11 presents the next step or preliminarily presents all the steps to worker B (skilled worker) of high skill level even if the report is not input in step b. The support system accepts a report of the worker B in step x and further makes an inquiry “Do you think reports in step b and step m are unnecessary?”. For example, the worker B may often give a response “unnecessary” alone or “the work from step b to step k should be executed urgently” to the inquiry. In the former case, the system does not need to further make an inquiry. In the latter case, the system 11 registers a set of the work procedure of steps b→c→ . . . →k which is set by the manual and a response “the work should be executed urgently” in the information database DB3. Moreover, the support system makes a response to urge more detailed information to be input. For example, the system makes a response “Why should the work from step b to step k be executed urgently?”.

For example, it is assumed that the worker B has made a response “If the work starts in step b and a sequence of confirmation ends in thirty minutes, the work following step m can be executed fast”. In this case, the support system 11 records the content that the report in step b may not be indispensable in accordance with the skill level. Moreover, if merits can be obtained from the response of the worker B, the system stores the merits in the information database DB3 (or the document database DB1 in some cases) together with the steps. For example, the system stores a set of steps b→c→ . . . →k, the time unit of thirty minutes, and the content that the efficiency of steps following step m is good. In addition, the system 11 does not set the work report of step k from the manual to be indispensable but, if the work report is input in step k by the worker B, the system 11 may store the content that the work report in step k may be indispensable.

Furthermore, if the storage of the contents similar to these reaches or exceeds the predetermined standard, the system may present the content to the worker of low skill level. For example, the system may modify the contents to present steps c to k simultaneously after presenting step c to the worker A and to urge the worker A to execute the steps as a series of works.

In addition, the system 11 comprises the worker database (list) DB2 and may determine whether the skill level and the current inspection work can be supported. The skill level is preliminarily set and registered as low level (evaluation score: 30), middle level (evaluation level: 50), high level (evaluation score: 80), and the like. For example, it is assumed that beginner A of skill level at 30 cannot understand the work content at work c and asks the system 11 about the work content. If an answer is not stored in the document database DB1, the system 11 calls supporter A who has the evaluation score of skill level higher than 30 and who can currently support the worker B, in the worker list, via a communication line. Furthermore, the system 11 registers a set of the question of the worker A and the answer of the worker B, in the information database DB3. The worker A returns to the work and executes the work in order of steps If the storage of the similar contents reaches or exceeds the predetermined standard, the system 11 responds to the inquiry from the worker by using the collected response information.

For example, if the report content of step b is not input by the beginner worker A of evaluation score of skill level at 30 after a predetermined time, the system 11 calls the supporter A who has the evaluation score of skill level higher than 30 and who can currently support the worker A, in the worker database DB2. For example, the system may connect a communication line between the supporter A and the worker A or present a content to urge the supporter A to confirm the state of the worker A. The system 11 collects information which can improve the situation from the supporter A (or may automatically collect the information in accordance with the manner of answering). The system 11 registers the acquired improvement information in the document database DB1 and updates the document database DB1. The worker A returns to the work and executes the work in order of steps c→d.

### Embodiment 3

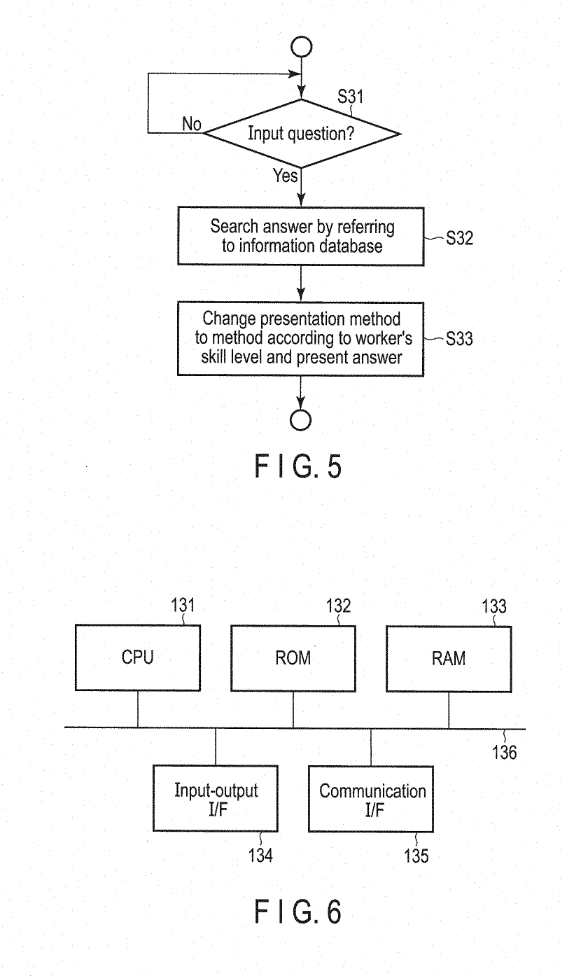

If the worker has a question about the work itself, the system responds to the worker in accordance with the skill level, by referring to the information database DB3. More specifically, as shown in FIG. 5, if the system 11 detects input of the question from the worker (step S31), the system 11 searches an answer to the question by referring to the information database DB3 (step S32), determines the skill level of the worker by referring to the worker database DB2, and presents the answer by changing the presentation method in accordance with the skill level (step S33). If the worker is a beginner of low skill level, the system connects a communication line between the supporter and the worker to enable direct dialog since the worker often cannot understand the registered information. In addition, if no answer is included in the information database DB3, the system may present a content to enable communication with the registered supporter.

As explained above, the support system having the above configuration presents the contents and work procedure of the inspection work registered in the knowledge database by changing the method of presentation in accordance with the inspection worker's skill level. If the worker asks a question about the inspection work, the system searches the knowledge database and presents the search result corresponding to the question as an answer. If the support processor cannot answer the question of the inspection worker of low skill level, the system connects the communication line to enable the supporter of higher skill level to answer the question. In addition, if the processing content of the worker of high skill level is compared with the registered content and the different work is executed, the system takes the processing content as know-how by considering the reason and reflects the know-how on the knowledge database. The system can thereby present an appropriate content corresponding to the skill level to the inspection worker, take know-how of inspection of the inspection worker of high skill level, adjust the environment of Q & A based on the difference in skill level, and attempt further increase in efficiency of the inspection work.

The support system 11 of the embodiments can be implemented by using, for example, a general-purpose computer as basic hardware. The memory unit 111, the detector 112, the processor 113, and the communication interface 114 can be implemented by urging the processor incorporated in the computer device to execute the program. As shown in FIG. 6, the computer device applicable to the support system comprises a controller such as a central processing unit (CPU) 131, storages such as a read only memory (ROM) 132 and a random access memory (RAM) 133, an input-output I/F 134 connected to a microphone, an operation input device, a display device, and the like, a communication I/F 135 connected to the network to execute communication, and a bus 136 which connects the units. The system may be implemented by preliminarily installing the program in the computer device, or by storing the program in a storage medium such as CD-ROM or distributing the program via a network and arbitrarily installing the program in the computer device. In addition, the document database DB1, the worker database DB2, and the information database DB3 can be implemented by arbitrarily using memories and hard disks built in or disposed externally to the computer device, or storage media such as CD-R, CD-RW, DVD-RAM, and DVD-R.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inspection work support system comprising:
a memory device configured to store a work manual including a predetermined work content and a predetermined work procedure, and worker information of a worker engaged in the work;
a detector configured to detect input from the worker; and
a change processor configured to change a method of presenting a content and a procedure of the work manual based on the input from the worker, based on a skill level of the worker for the work obtained by referring to the worker information.

2. The inspection work support system of claim 1, wherein
if a question from the work is input, the change processor searches and presents the work manual.

3. The inspection work support system of claim 1, further comprising:
a support processor configured to make a response to the question from the worker,
wherein
if the support processor is unable to make a response to the question, the support processor urges a supporter different from the worker who has asked the question to make a response to the question.

4. The inspection work support system of claim 3, wherein
the support processor configured to compare a processing content of a worker of a high skill level with a content corresponding to the work manual and, if a different work content or work procedure is executed, the support processor urges the worker to input a reason for executing the work content or work procedure.

5. An inspection work supporting method comprising:
preliminarily storing a work manual including a predetermined work content and a predetermined work procedure, and worker information on a worker engaged in the work;
detecting input from the worker; and
changing a method of presenting a content and a procedure of the work manual based on the input from the worker, based on a skill level of the worker for the work obtained by referring to the worker information.

6. A non-transitory computer-readable storage medium having stored thereon a computer program which is executable by a computer used in an inspection work support program, the computer program comprising instructions capable of causing the computer to execute functions of:
storing a work manual including a predetermined work content and a predetermined work procedure, and worker information of a worker engaged in the work;
detecting input from the worker; and
changing a method of presenting a content and a procedure of the work manual based on the input from the worker, based on a skill level of the worker for the work obtained by referring to the worker information.
